(19) United States
(12) Patent Application Publication
(10) Pub. No.: US 2026/0148051 A1
(43) Pub. Date: May 28, 2026

(54) ELECTRONIC CIRCUIT FOR IMPLEMENTING A BAYESIAN NEURAL NETWORK

(71) Applicants: Commissariat à l’Energie Atomique et aux Energies Alternatives, Paris (FR); Centre national de la recherche scientifique, Paris (FR); Université d’Aix-Marseille, Marseille (FR)

(72) Inventors: Tarcisius JANUEL, Grenoble Cedex 9 (FR); Elisa VIANELLO, Grenoble Cedex 9 (FR); Olivier BILLOINT, Grenoble Cedex 9 (FR); Jean-Michel PORTAL, Marseille Cedex 07 (FR)

(73) Assignees: Commissariat à l’Energie Atomique et aux Energies Alternatives, Paris (FR); Centre national de la recherche scientifique, Paris (FR); Université d’Aix-Marseille, Marseille (FR)

(21) Appl. No.: 19/401,490

(22) Filed: Nov. 26, 2025

(30) Foreign Application Priority Data
Nov. 26, 2024 (FR) FR2412984

(51) Int. Cl. G06N 3/063

(52) U.S. Cl. CPC G06N 3/063

(57) ABSTRACT

The invention relates to an electronic circuit for implementing a Bayesian neural network, comprising bit, source, and word lines; and
at least one primary branch, each including a primary cell connected between the source and the bit lines and including a primary memory component and a primary switch connected in series,
at least one secondary branch, each including a secondary cell connected between the source and the bit lines and including a secondary memory component and a secondary switch connected between them,
an accumulation device configured to accumulate a total amount being the sum of a primary amount of charges from a primary cell and a secondary amount of charges from a secondary cell, the primary and secondary amounts being accumulated independently of each other.

### CROSS-REFERENCE TO RELATED APPLICATIONS

This application is a U.S. non-provisional application claiming the benefit of French Application No. 24 12984, filed on Nov. 26, 2024, which is incorporated herein by reference in its entirety.

### FIELD

The present invention relates to an electronic circuit for implementing a Bayesian neural network.

The invention then relates to the field of electronic circuits able to implement, notably inference, of neural networks, particularly Bayesian neural networks.

Bayesian networks are particularly suited for security applications, such as healthcare or autonomous driving. One of the strengths of these networks is to quantify the uncertainty of results based on input data. In the example of a classifier, once learning is completed, the dispersion of results allows to identify two types of uncertainty: either the classification is unclear (noisy data or inputs correspond to features of several classes at the same time), or the classification is unknown.

### BACKGROUND

Neural networks are generally classified into two families: deterministic neural networks, which provide a deterministic output for a given input; and Bayesian neural networks, also called probabilistic neural networks, which are based on Bayesian deep learning models and which encode synaptic parameters, notably synaptic weights, using probability distributions.

In deterministic neural networks, weights are real numbers, and the output of each neuron is the weighted sum of its inputs, to which an activation function is then applied.

Instead of choosing fixed weights for learning, Bayesian neurons sample their weights from distributions. Rather than using any distribution, Gaussian (or normal) distributions have the advantage of simplifying the formulation and evaluation of a Bayesian model using the properties of Gaussian random variables.

To generate a Gaussian distribution, a first approach is to generate this distribution from a multitude of memory components, such as oxide-based resistive random access memories, also called OxRAM. Each sample of the Gaussian is then obtained by programming a respective memory component. This first approach is described, for example, in the article “In situ learning using intrinsic memristor variability via Markov chain Monte Carlo sampling” by Dalgaty et al., published in Nature Electronics in 2021, as well as in the article “Bringing uncertainty quantification to the extreme-edge with memristor-based Bayesian neural networks” by Bonnet et al., published in Nature Communications in 2023.

However, according to this first approach, the hardware implementation of the Bayesian neural network results in a large surface electronic circuit since a memory is needed for each sample of the Gaussian distribution.

A second approach to generate the Gaussian distribution is to store the main properties of the Gaussian distribution, namely its mean value and standard deviation, in memory components, and then perform read operations with these components to generate random values representative of this Gaussian distribution.

According to this second approach, EP 4 174 724 B1 describes a synapse circuit for a Bayesian neural network, the circuit comprising a first resistive memory device coupling a first voltage rail to a first terminal of a capacitor, the first terminal of the capacitor being coupled to a second voltage rail via a variable conductance; and a second resistive memory device coupling a third voltage rail to a first output line of the synapse circuit, a second terminal of the capacitor being coupled to a terminal of the second resistive memory device.

For generating a random value of the Gaussian distribution, in the form of a current signal on an output line of the synapse circuit, this document then describes programming the first resistive memory device to have a first level of conductance; programming the second resistive memory device so as to have a second level of conductance; and applying a voltage to the first voltage rail to generate a current signal on the output line.

However, with such a synapse circuit, the capacitor between the first resistive memory device and the second resistive memory device induces a certain correlation between the two devices and creates a problematic dependency between the mean value and the standard deviation of the generated distribution. Furthermore, document EP 4 174 724 B1 proposes exploiting the thermal noise of the first resistive memory device as the main source of variability but does not provide a solution in the case where this same memory device is subject to random telegraph noise.

### SUMMARY

The aim of the invention is to propose an electronic circuit allowing to generate a Gaussian distribution with better control for implementing a Bayesian neural network, while maintaining restricted dimensions.

To this end, the invention has as its object an electronic circuit for implementing a Bayesian neural network, comprising:
bit lines;
source lines;
at least one word line;
at least one primary branch, the or each primary branch including at least one primary cell connected between a respective source line and bit line, the or each primary cell including a primary memory component and a primary switch connected in series, the primary switch having a control electrode connected to a respective word line,
at least one secondary branch, the or each secondary branch including at least one secondary cell connected between a respective source line and bit line, the or each secondary cell including a secondary memory component and a secondary switch connected between them,
the source and bit lines associated with the or each secondary branch being distinct from the source and bit lines associated with the or each primary branch,
an accumulation device connected to the primary and secondary branches and configured to accumulate a total amount of electrical charges from a respective pair of cells, the pair being formed of a respective primary cell and a respective secondary cell, the total amount being the sum of a primary amount of charges from said primary cell and a secondary amount of charges from said secondary cell, the primary and secondary amounts being accumulated independently of each other.

With the electronic circuit according to the invention, each standard deviation of the Gaussian distribution is stored in a respective primary cell and each mean value of the Gaussian distribution is stored in a respective secondary cell, and the accumulation of the primary and secondary amounts independently of each other then allows to reduce a correlation between the mean value and the standard deviation of the generated distribution, each random value of the generated Gaussian distribution being obtained from a respective value of the total accumulated amount. An independent accumulation of charge between said primary and secondary branches allows to define different integration times for each of the branches. This is an additional design parameter to control the correlation between the branches.

To this end also, each primary cell is included in a corresponding primary branch, and each secondary cell is included in a corresponding secondary branch, the or each secondary branch being distinct from the or each primary branch and arranged in parallel with them.

During a sampling operation to obtain multiple samples of the Gaussian distribution, each sample results, for example, from a value of an output voltage of the accumulation device, this output voltage depending on the total accumulated amount.

Preferably, each primary, secondary memory component includes an oxide-based resistive memory, or OxRAM, which then allows to take advantage of the read-to-read variability of the OxRAM for the sampling operation.

According to other advantageous aspects of the invention, the electronic circuit comprises one or more of the following features, taken individually or in any technically possible combination:
the primary amount is accumulated over two successive phases: a charge phase with a first voltage value applied to the corresponding source line, and a discharge phase with a second voltage value applied to said source line, the second value being distinct from the first value;
the or each primary branch further includes a voltage to current converter of the primary cell, the voltage to current converter being connected between an additional potential and the accumulation device, the voltage to current converter having a control electrode connected to the primary cell via the corresponding bit line;
the additional potential presents a value higher than a reference potential at the input of the accumulation device during the charge phase, and a value lower than the reference potential at the input of the accumulation device during the discharge phase;
the or each primary branch further includes a variable conductance, connected between a reference potential and the control electrode of the voltage to current converter;
the or each primary branch further includes a capacitor having one terminal connected to the control electrode of the voltage to current converter and the other terminal to a reference potential;
the or each primary branch preferably including an auxiliary switch connected between the terminal of the capacitor connected to said control electrode and a pre-charge potential of the capacitor;
the electronic circuit further includes a cascode, called primary cascode, connected between the or each primary branch and the accumulation device;
the or each primary memory component is a memory sensitive to random telegraph noise;
the or each primary memory component being preferably a memory chosen from among the group consisting of: an oxide-based resistive memory; a conductive bridging random access memory; a phase-change memory; a magnetic random access memory; and a ferroelectric tunnel junction memory;
the or each secondary memory component is a memory chosen from among the group consisting of: an oxide-based resistive memory; a conductive bridging random access memory; a phase-change memory; a magnetic random access memory; and a ferroelectric stack memory such as a ferroelectric capacitor or a ferroelectric tunnel junction memory;
the secondary memory component and the secondary switch are connected in series between the source line and the respective bit line, the secondary switch having a control electrode connected to a respective word line;
the or each secondary memory component is a component chosen from among the group consisting of: a ferroelectric memory field effect transistor; and a ferroelectric field effect transistor;
the secondary memory component is connected between the source line and the respective bit line, and the secondary switch is connected between a word line and a control electrode of the secondary memory component;
the electronic circuit further includes a cascode, called secondary cascode, connected between the or each secondary branch and the accumulation device;
the accumulation device includes at least one transimpedance amplifier;
the electronic circuit comprises N primary branches and N secondary branches arranged in N pairs of primary and secondary branches, and the accumulation device includes N transimpedance amplifiers, each being connected to a respective pair of primary and secondary branches, N being an integer greater than or equal to 2;
the electronic circuit comprises N secondary branches, N being an integer greater than or equal to 2;
the electronic circuit comprises a single primary branch;
the electronic circuit comprises N primary branches; and
the accumulation device includes a single capacitive transimpedance amplifier.

### BRIEF DESCRIPTION OF THE DRAWINGS

These features and advantages of the invention will become clearer upon reading the following description, given solely by way of non-limiting example, and made with reference to the appended drawings, in which:

FIG. 1 is a schematic representation of an electronic circuit, according to the invention, comprising bit lines; source lines; at least one word line; at least one primary branch, each including at least one primary cell including a primary memory component and a primary switch; at least one secondary branch, each including at least one secondary cell including a secondary memory component and a secondary switch; and an accumulation device connected to the primary and secondary branches to accumulate a total amount of electrical charges from a respective pair of cells; FIG. 1 being according to a first embodiment of the circuit without the addition of a cascode, according to a first example embodiment of the primary branch with, in addition, a voltage to current converter of the primary cell, according to a first type, called capacitive, of primary cell, and according to a first type of secondary cell;

FIG. 2 is a partial schematic representation of the electronic circuit where the secondary branch and the accumulation device are not represented, according to a second embodiment of the circuit with, in addition, a cascode, called primary cascode, connected between a respective primary branch and the accumulation device;

FIG. 3 is a set of schematic curves of different magnitudes illustrating the operation of the electronic circuit according to the second embodiment and according to a first implementation where a square-shaped signal, that is, in the form of a square wave, is applied to the primary memory component in order to polarize the primary cell;

FIG. 4 is a view similar to that of FIG. 3, according to a second implementation where a triangular shaped signal is applied to a capacitor of the primary branch in order to polarize the primary cell;

FIG. 5 is a schematic representation of the primary branch, according to a second type, called resistive, of primary cell, and according to a first example without the addition of variable conductance;

FIG. 6 is a set of schematic curves of different magnitudes illustrating the operation of the primary branch of FIG. 5;

FIG. 7 is a schematic representation of the primary branch and the secondary branch connected in parallel, the primary branch being according to the second type, called resistive, of primary cell, and according to a second example with the addition of variable conductance;

FIG. 8 is a view similar to that of FIG. 6, for the primary cell of FIG. 7;

FIG. 9 is a partial schematic representation of the electronic circuit where the primary branch and the accumulation device are not represented, according to a third embodiment of the circuit with, in addition, a cascode, called secondary cascode, connected between a respective secondary branch and the accumulation device;

FIG. 10 is a schematic representation of the secondary branch, according to a second type of secondary cell where the secondary memory component is a FeFET or a FeMFET;

FIG. 11 is a schematic representation of the parallel arrangement of several primary and secondary branches of the circuit, each branch typically including several cells, according to a first arrangement with N primary branches, N secondary branches, N≥2, and the accumulation device including a single transimpedance amplifier connected to said N primary and secondary branches;

FIG. 12 is a schematic view of an example of implementation with representation of line control logic units in the case of a primary branch and a secondary branch connected in parallel at the input of a transimpedance amplifier, according to a fourth embodiment of the circuit with both the primary cascode connected between the primary branch and the accumulation device and the secondary cascode connected between the secondary branch and the accumulation device;

FIG. 13 is a view similar to that of FIG. 12, in the case of two primary branches connected in parallel at the input of the transimpedance amplifier; and

FIG. 14 illustrates two schematic representations of the parallel arrangement of the primary and secondary branches of the circuit; one being according to a second arrangement with N pairs of primary and secondary branches, N≥2, and the accumulation device including N transimpedance amplifiers, each being connected to a respective pair of primary and secondary branches; the other being according to a third arrangement with a single primary branch, N secondary branches, N≥2, and the accumulation device including a single transimpedance amplifier connected to said primary and secondary branches.

### DETAILED DESCRIPTION

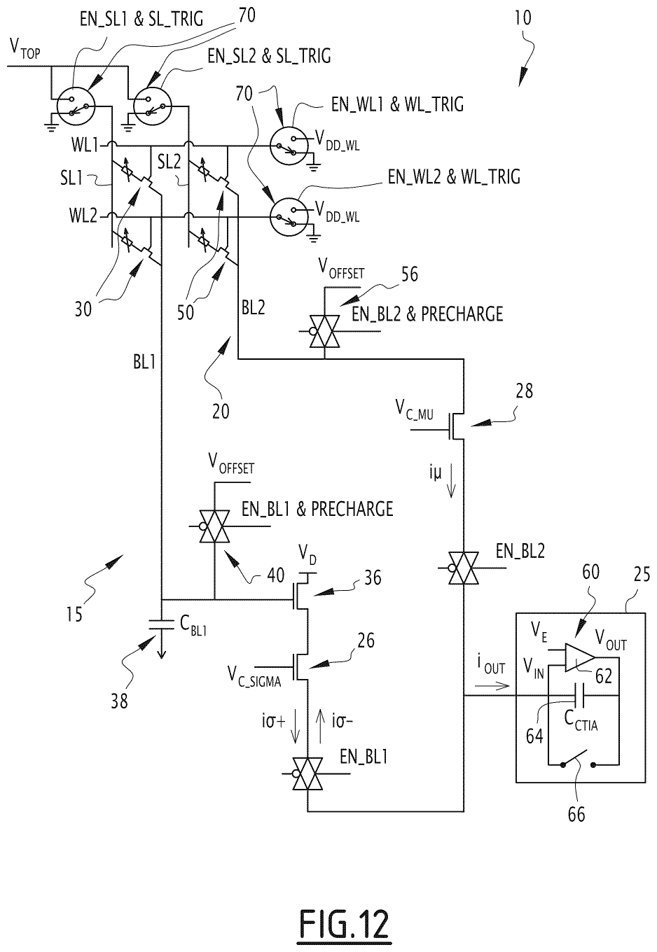

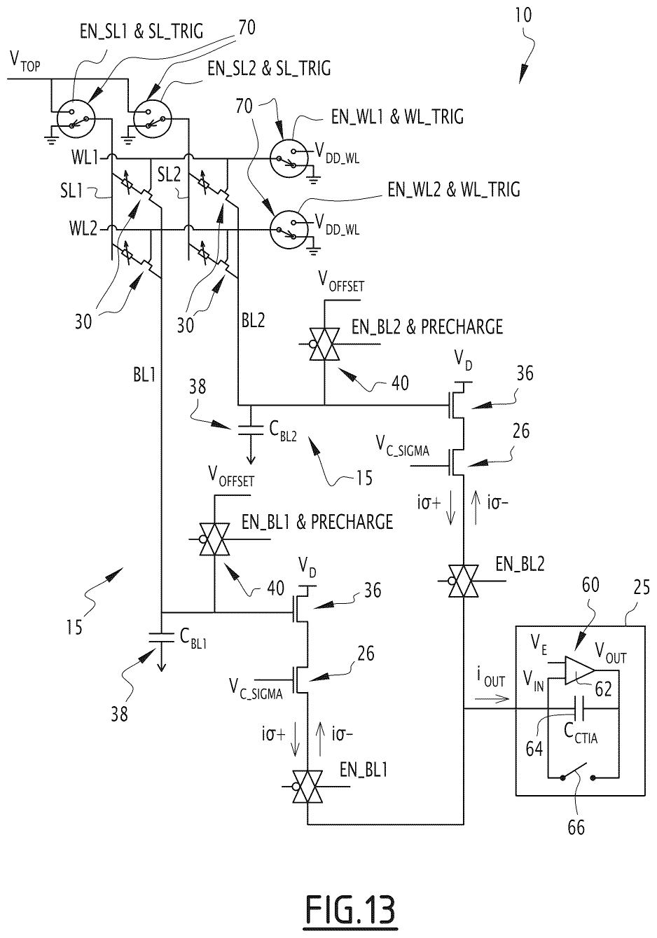

An electronic circuit 10 for implementing a Bayesian neural network comprises bit lines BLj, with j being an integer index greater than or equal to 1, such as the first BL1 and second BL2 bit lines, visible in FIGS. 12 and 13; source lines SLj, such as the first SL1 and the second SL2 source lines, also visible in FIGS. 12 and 13; and at least one word line WLi, with i being an integer index greater than or equal to 1, such as the first WL1 and the second WL2 word lines, represented in FIGS. 12 and 13.

The electronic circuit 10 also comprises at least one primary branch 15, at least one secondary branch 20, and an accumulation device 25 connected to the primary branch(es) 15 and the secondary branch(es) 20.

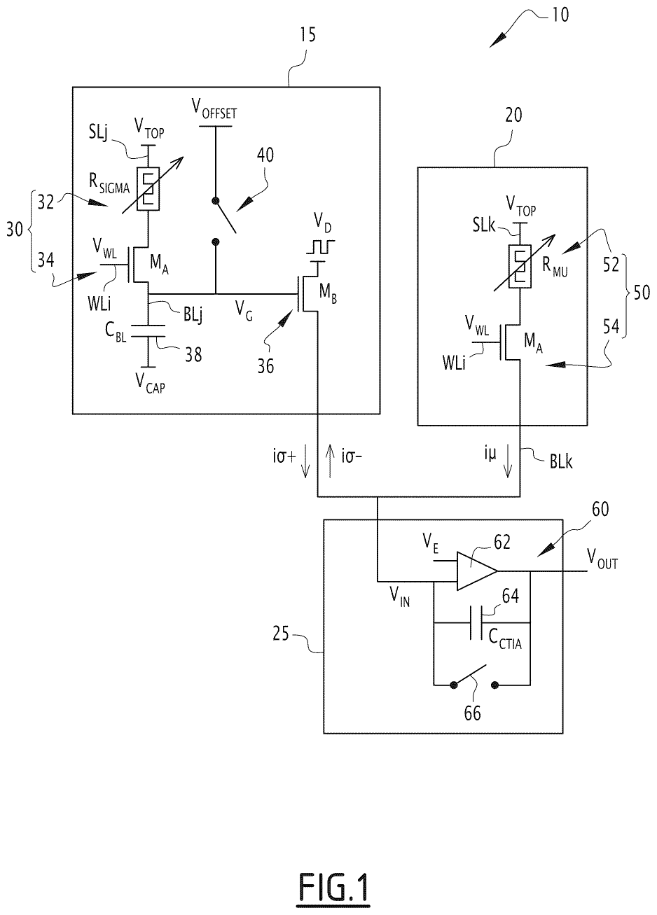

In the example of FIG. 1, the electronic circuit 10 represented, comprises a single primary branch 15 and a single secondary branch 20.

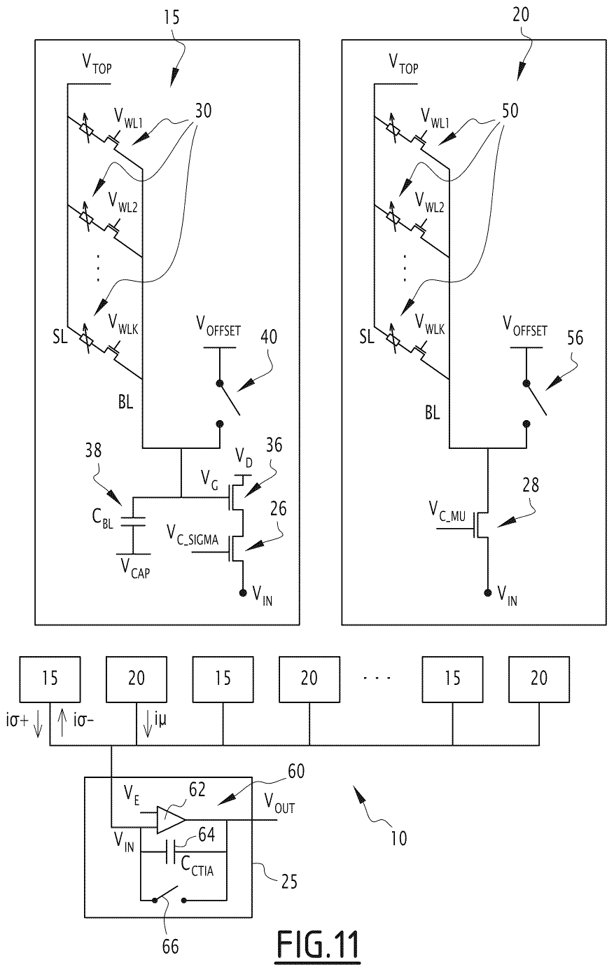

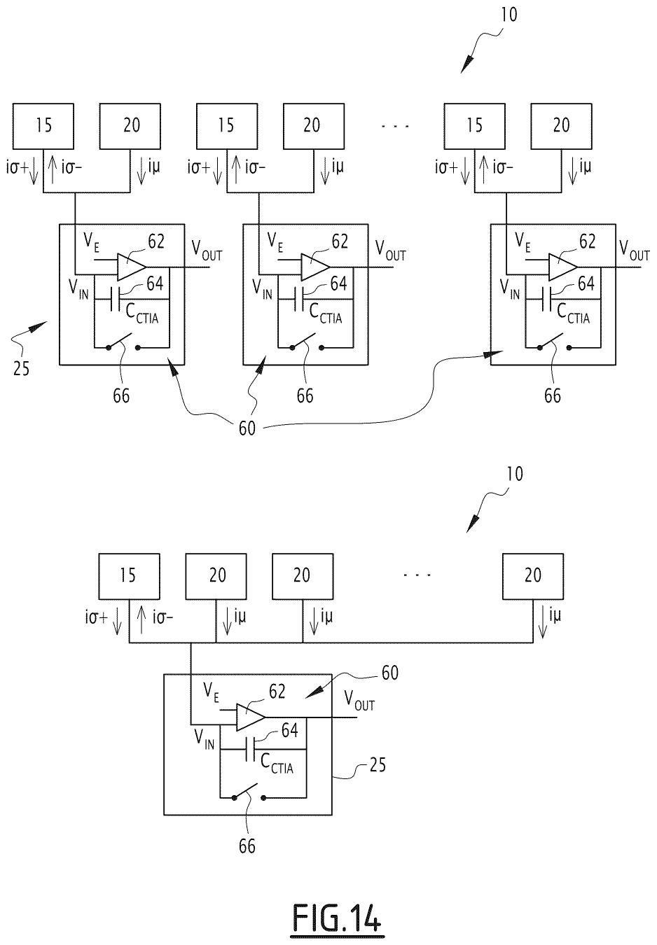

In FIGS. 11 and 14 representing different examples of parallel arrangement of the primary branch(es) 15 and the secondary branch(es) 20, the electronic circuit 10 comprises several secondary branches 20 and one or more primary branches 15 according to the examples.

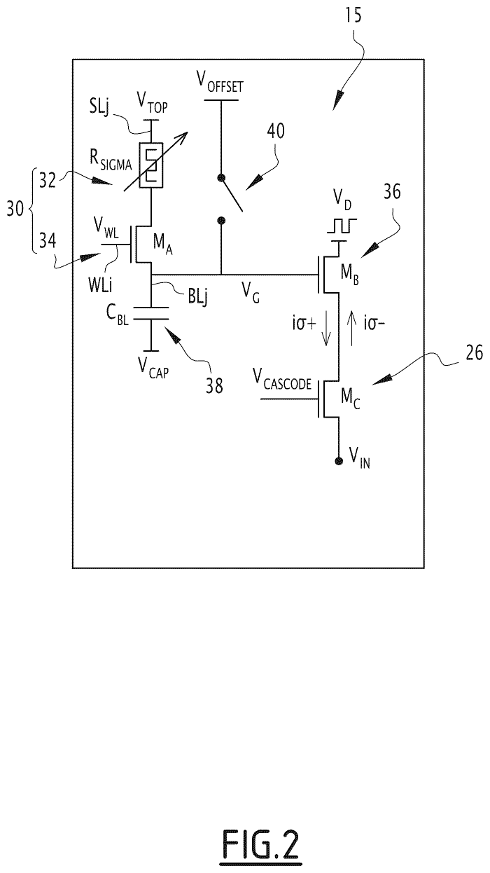

In an optional addition, such as in the examples of FIGS. 2 and 11 to 13, the electronic circuit 10 further comprises a cascode, called primary cascode 26, connected between a respective primary branch 15 and the accumulation device 25.

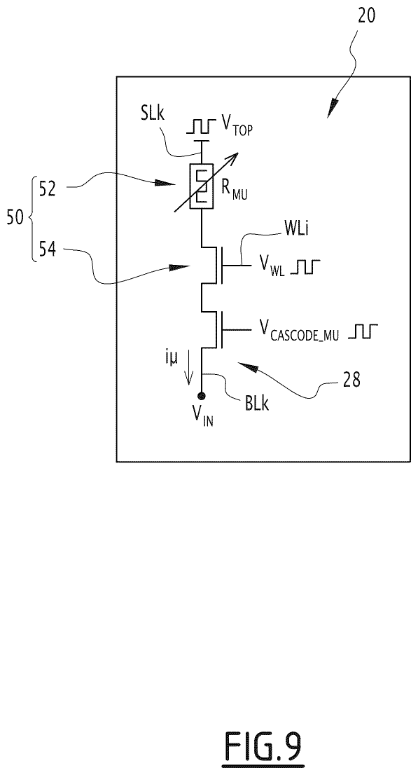

In another optional addition, such as in the examples of FIGS. 9, 11, and 12, the electronic circuit 10 further includes another cascode, called secondary cascode 28, connected between a respective secondary branch 20 and the accumulation device 25.

Each primary branch 15 includes at least one primary cell 30 connected between a respective source line SLj and a bit line BLj, each primary cell 30 including a primary memory component 32 and a primary switch 34 connected in series.

In the examples of FIGS. 11 to 13, each primary branch 15 includes several primary cells 30 connected in parallel to each other between the respective source line SLj and the bit line BLj, each primary cell 30 having one end connected to said source line SLj and the other end connected to said bit line BLj.

In addition, according to a first example of realization of the primary branch 15, such as represented in FIGS. 1, 2, 7, and 11 to 13, the primary branch 15 further includes a voltage to current converter 36 of the primary memory cell 30, the voltage to current converter 36 being connected between an additional potential V_{D} and the accumulation device 25.

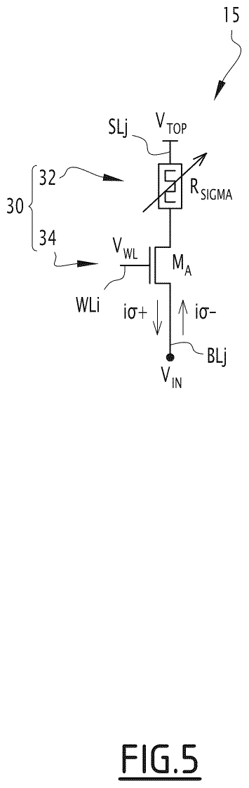

Alternatively, according to a second example of realization of the primary branch 15, such as represented in FIG. 5, the primary branch 15 does not include a voltage to current converter.

According to a first type, called capacitive, of the primary branch 15, such as represented in FIGS. 1 to 4 and 11 to 13, the primary branch 15 further includes a capacitor 38 having one terminal connected to the voltage to current converter 36 and the other terminal to a reference potential V_{CAP}.

According to this first type, the primary branch 15 advantageously includes a first auxiliary switch 40 connected between the terminal of the capacitor 38 that is connected to the voltage to current converter 36 and a pre-charge potential V_{OFFSET} of the capacitor 38.

The first auxiliary switch 40 then serves to pre-charge the capacitor 38. The first auxiliary switch 40 also serves to provide access for programming the corresponding primary cell(s) 30.

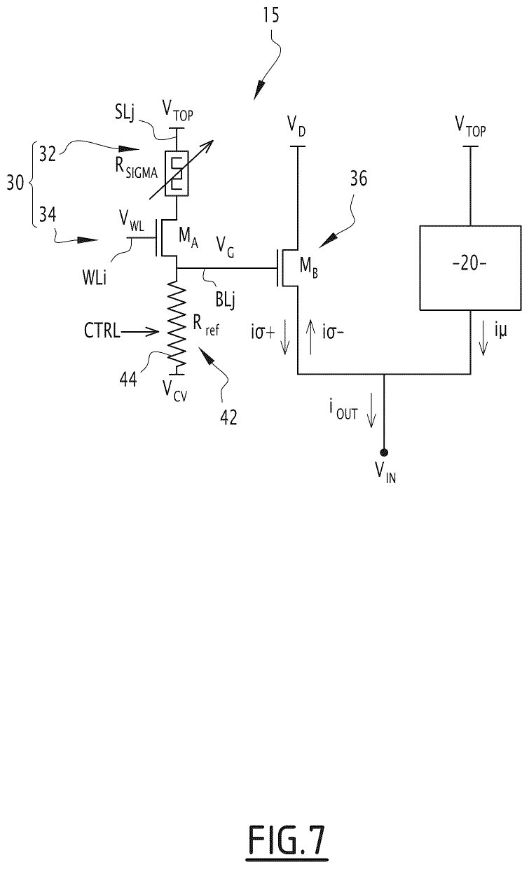

Alternatively, the primary branch 15 is of a second type, called resistive, such as represented in FIGS. 5 and 7.

In the example of FIG. 5, the primary branch 15 includes only the primary cell 30, in other words, only the primary memory component 32 and the primary switch 34.

In the example of FIG. 7, according to an optional addition for the second type, called resistive, of the primary branch 15, the primary branch 15 further includes a variable conductance 42, connected between a reference potential V_{CV} and the voltage to current converter 36. The variable conductance 42 is, for example, a variable resistor 44 the resistance value Rref of which, is controlled by the parameter CTRL.

Each primary branch 15 is also called the first branch. In addition, with the electronic circuit 10 according to the invention, each standard deviation of the Gaussian distribution is stored in a respective primary cell 30. The standard deviation being generally represented by the Greek letter sigma, each primary branch 15 is also called the sigma branch.

Each secondary branch 20 includes at least one secondary cell 50 connected between a respective source line SLk and a bit line BLk, each secondary cell 50 including a secondary memory component 52 and a secondary switch 54 connected between them.

The source lines SLk and the bit lines BLk associated with each secondary branch 20 are distinct from the source lines SLj and the bit lines BLj associated with each primary branch 15.

In the examples of FIGS. 11 and 12, each secondary branch 20 includes several secondary cells 50 connected in parallel to each other between the respective source line SLj and the bit line BLj, each secondary cell 50 having one end connected to said source line SLj and the other end connected to said bit line BLj.

In an optional addition, the secondary branch 20 includes a second auxiliary switch 56 connected between the secondary cascode 28 and the pre-charge potential V_{OFFSET}, as represented in FIGS. 11 and 12. The second auxiliary switch 56 serves to provide access for programming the corresponding secondary cell(s) 50.

Each secondary branch 20 is also called the second branch. Furthermore, with the electronic circuit 10 according to the invention, each mean value of the Gaussian distribution is stored in a respective secondary cell 50. The mean value being generally represented by the Greek letter mu, each secondary branch 20 is also called the mu branch.

The accumulation device 25 is configured to accumulate the total amount Qₜₒₜ of electrical charges from a respective pair of cells 30, 50, the pair being formed of a respective primary cell 30 and a respective secondary cell 50, the total amount Qₜₒₜ being the sum of a primary amount Q_{σ} of charges from said primary cell 30 and a secondary amount Q_{μ} of charges from said secondary cell 50, the primary amount Q_{σ} and the secondary amount Q_{μ} being accumulated independently of each other.

Advantageously, the accumulation device 25 is configured to accumulate the primary amount Q_{σ} over two successive phases, namely a charge phase with a first voltage value V_{TOP+} applied to the corresponding source line SLj, and a discharge phase with a second voltage value V_{TOP-} applied to said source line SLj, the second value V_{TOP-} being distinct from the first value V_{TOP+}.

When, in addition, the primary branch 15 further includes the voltage to current converter 36 connected between the additional potential V_{D} and the accumulation device 25, the additional potential V_{D} preferably presents a value V_{D+} higher than a reference potential V_{E} at the input of the accumulation device 25 during the charge phase, and a value V_{D-} lower than the reference potential V_{E} at the input of the accumulation device 25 during the discharge phase.

In the examples of FIGS. 1 and 11 to 14, the accumulation device 25 includes at least one transimpedance amplifier 60. The transimpedance amplifier 60 is known in itself and is also noted TIA (from the English Transimpedance Amplifier). The transimpedance amplifier 60 is configured to convert an input current into a proportional output voltage V_{OUT}. Advantageously, the transimpedance amplifier 60 is a capacitive transimpedance amplifier, also noted CTIA (from the English Capacitive Transimpedance Amplifier), including one or more capacitive elements to improve certain performance characteristics, such as frequency response and noise reduction.

In the examples of FIGS. 1 and 11 to 14, the transimpedance amplifier 60 is a CTIA and includes an operational amplifier 62 receiving at its input terminals, on the one hand, the reference potential V_{E}, described previously, and on the other hand, an input voltage V_{IN} at the connection point of the respective pair of primary cells 30 and secondary cells 50, and delivering at its output terminal the output voltage V_{OUT}. The transimpedance amplifier 60 further includes a feedback capacitor 64 of capacity C_{CTIA} and a control switch 66, the feedback capacitor 64 and the control switch 66 being connected in parallel to each other between the output terminal of the operational amplifier 62 and the input terminal receiving the input voltage V_{IN}.

In the examples of FIGS. 1 and 11 to 13, as well as in the lower part of FIG. 14, the accumulation device 25 includes a single transimpedance amplifier 60. Alternatively, such as in the example in the upper part of FIG. 14, the accumulation device 25 includes several transimpedance amplifiers 60, typically with a transimpedance amplifier 60 for each pair of primary and secondary branches.

Each primary memory component 32 is advantageously a memory sensitive to random telegraph noise, also called RTN (from the English Random Telegraphic Noise).

Each primary memory component 32 is advantageously a non-volatile memory.

Each primary memory component 32 is, for example, a memory chosen from among the group consisting of: an Oxide-based Resistive Random Access Memory, also called OxRAM; a Conductive Bridging Random Access Memory, also called CBRAM; a Phase-Change Memory, also called PCM; a Magnetoresistive Random Access Memory, also called MRAM; and a Ferroelectric Tunnel Junction Memory, also called FTJ.

In the examples of FIGS. 1 to 8 and 11 to 13, the primary memory component 32 is a resistive random access memory, with resistance noted R_{SIGMA}.

Each of the switches from among the primary switch 34, the first auxiliary switch 40, the secondary switch 54, and the second auxiliary switch 56 and the control switch 66 includes two conduction electrodes and a control electrode to control the switching of the corresponding switch between a passing state in which a current flows between the conduction electrodes and a blocked state in which the current does not flow between the conduction electrodes. The skilled person will observe that when the considered switch is a transistor, such as a metal-oxide-semiconductor field-effect transistor, or MOSFET (from the English Metal Oxide Semiconductor Field Effect Transistor), then the conduction electrodes are the drain and source electrodes, and the control electrode is the gate electrode.

The primary switch 34 has its control electrode connected to a respective word line WLi. The primary switch 34 is used for programming the primary memory component 32 to which it is connected. In other words, the primary switch 34 is used for storing the desired value in the primary memory component 32.

In the examples of FIGS. 1 to 8 and 11 to 13, the primary switch 34 is a MOSFET transistor, noted M_{A}, the gate electrode of which is controlled by a voltage V_{WL} associated with the respective word line WLi.

The voltage to current converter 36 has its control electrode connected to the primary memory cell via the corresponding bit line BLj. The voltage to current converter 36 is used to amplify variations of a voltage V_{G} from the primary memory component 32 via the corresponding bit line BLj.

In the examples of FIGS. 1 to 4, 7, 8, and 11 to 13, the voltage to current converter 36 is a MOSFET transistor, noted M_{B}, the gate electrode of which is controlled by the voltage V_{G}.

The capacitor 38 has one terminal connected to the control electrode of the voltage to current converter 36 and the other terminal to a reference potential V_{CAP} and presents a capacitance C_{BL}.

The first auxiliary switch 40 is connected between the pre-charge potential V_{OFFSET} of the capacitor 38 and the terminal of the capacitor 38 that is connected to the control electrode of the voltage to current converter 36.

The variable conductance 42 is connected between the reference potential V_{CV} and the control electrode of the voltage to current converter 36. In the example of FIG. 7, the variable conductance 42 is performed via the variable resistor 44 controlled by the parameter CTRL.

Each secondary memory component 52 is advantageously a non-volatile memory.

In the examples of FIGS. 1, 9, 11, and 12, according to a first type of secondary cell 50, each secondary memory component 52 is a memory chosen from among the group consisting of: an oxide-based resistive memory, also called OxRAM; a conductive bridging random access memory, also called CBRAM; a phase-change memory, also called PCM; a magnetic random access memory, also called MRAM; and a ferroelectric tunnel junction memory, also called FTJ; and a ferroelectric memory also called FeRAM.

In these examples of FIGS. 1, 9, 11, and 12, the secondary memory component 52 and the secondary switch 54 are connected in series between the respective source line SLk and the bit line BLk, the secondary switch 54 having a control electrode connected to a respective word line WLj.

In these examples of FIGS. 1, 9, 11, and 12, the secondary memory component 52 is a resistive random access memory, with resistance noted R_{MU}.

Alternatively, according to a second type of secondary cell 50, each secondary memory component 52 includes a field-effect transistor using a ferroelectric material.

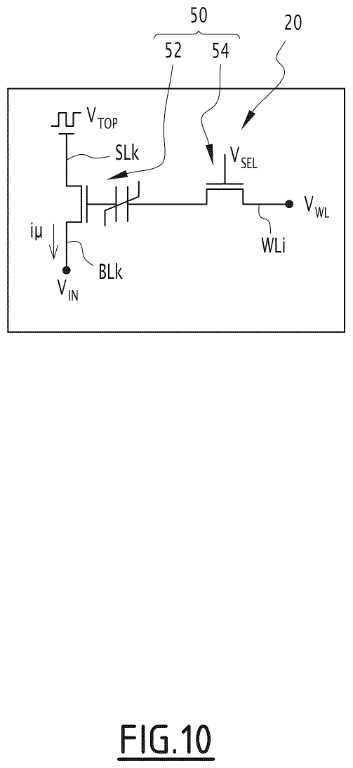

According to this alternative, each secondary memory component 52 is, for example, a ferroelectric memory field-effect transistor, also called FeMFET (from the English Ferroelectric-Metal Field-Effect Transistor), as represented in FIG. 10; or even a ferroelectric field-effect transistor, also called FeFET (from the English Ferroelectric Field-Effect Transistor). The FeMFET is a type of field-effect transistor the gate of which is connected to a ferroelectric capacitor realized by a metal-dielectric-ferroelectric-metal junction. The polarization of the ferroelectric layer modifies the electrical properties of the FeMFET, allowing its use in non-volatile memory. The FeFET is a field-effect transistor using a ferroelectric material as a gate dielectric, and the polarization of the ferroelectric dielectric allows to control the conduction channel, thus offering a non-volatile memory with characteristics similar to those of MOSFET transistors. In both cases, the FeMFET and the FeFET are subject to a shift in their threshold voltages when the ferroelectric polarization changes.

According to this alternative, the secondary memory component 52 is connected between the respective source line SLk and the bit line BLk, and the secondary switch 54 is connected between a word line WLj and a control electrode of the secondary memory component 52. According to this alternative, the secondary switch 54 is then configured to select the secondary memory component 52 to which it is associated, this selection being performed by applying the voltage V_{SEL} to the control electrode of the secondary switch 54, and when the secondary switch 54 is in its passing state, it then allows the application of the voltage V_{WL} to the control electrode of the secondary memory component 52, this voltage V_{WL} being received via the word line WLi connected to the secondary switch 54.

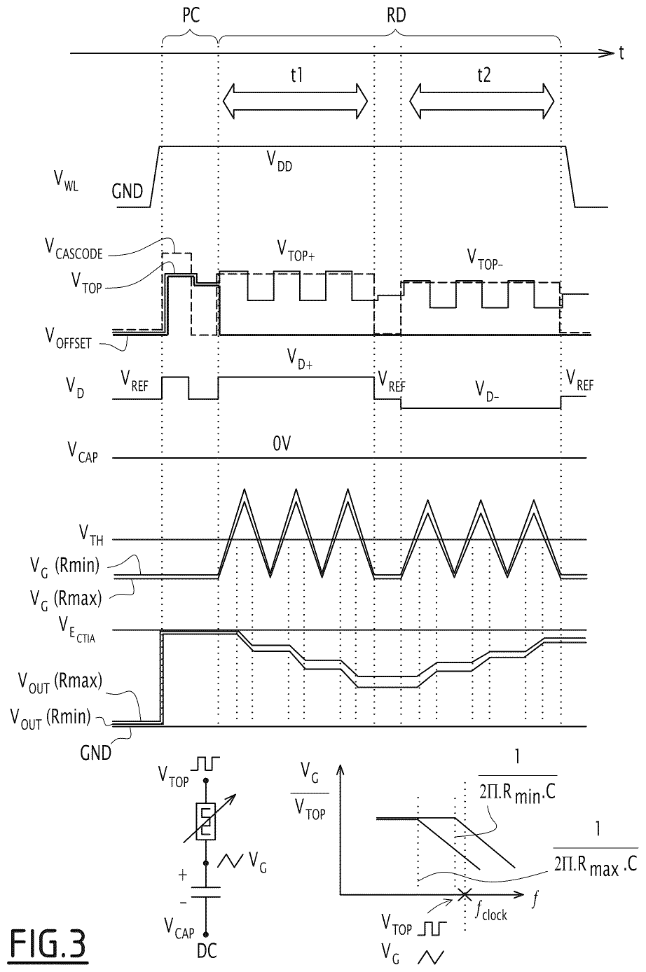

The operation of the electronic circuit 10 according to the invention will now be explained, notably in relation to FIGS. 3, 4, 6, and 8, these figures representing sets of schematic curves of different magnitudes involved in the operation of the electronic circuit 10 according to the invention, notably of different voltages applied to elements of the electronic circuit 10.

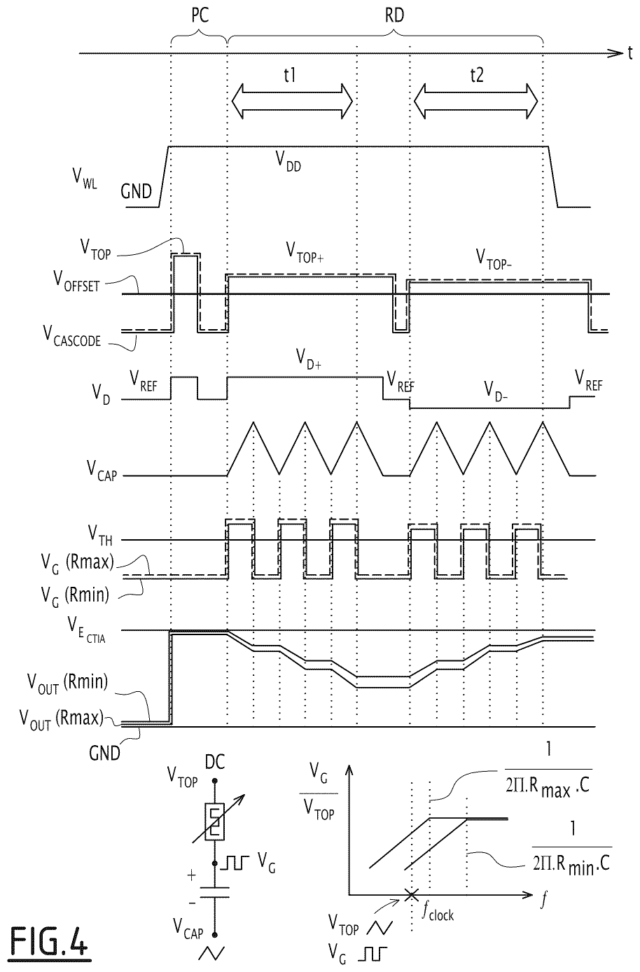

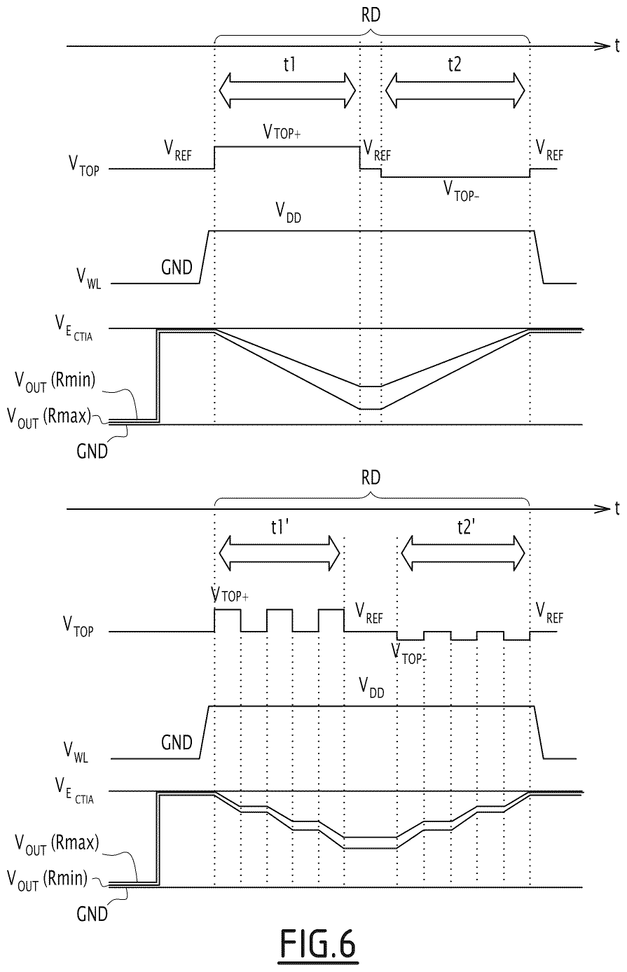

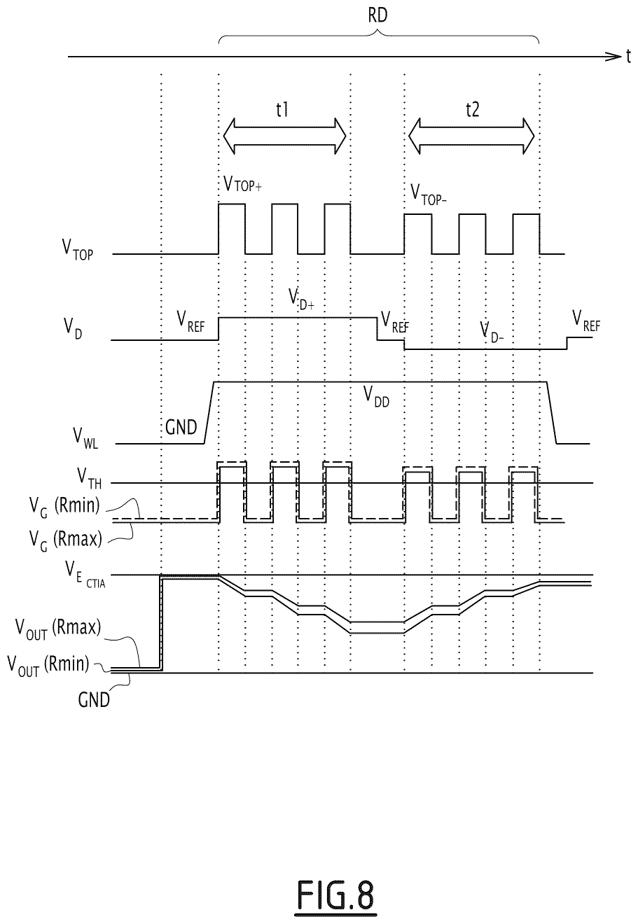

The skilled person will observe, in particular, that the voltages represented on each of these FIGS. 3, 4, 6, and 8 correspond to those indicated on the electronic circuit 10 of each of the preceding figures, the voltages represented in FIGS. 3 and 4 being then visible in FIG. 2, and partially in FIG. 1, similarly the voltages represented in FIG. 6 being visible in FIG. 5, and those represented in FIG. 8 being visible in FIG. 7.

Thus, in FIGS. 3 and 4, the voltages are respectively as follows, from top to bottom:
the voltage V_{WL} applied to the control electrode of the primary switch 34 via the word line WLi, this voltage V_{WL} varying between a low potential formed by the ground potential GND of an electrical ground and a high potential noted V_{DD};
a voltage V_{CASCODE} applied to the control electrode of the primary cascode 26, represented in dashed line;
the voltage V_{TOP} applied to the primary memory component 32 via the source line SLj, taking notably the first voltage value V_{TOP+} in the charge phase and the second voltage value V_{TOP-} in the discharge phase;
a voltage V_{OFFSET} applied at one end of the first auxiliary switch 40 and serving to pre-charge the capacitor 38;
a voltage V_{D} applied at one end of the voltage to current converter 36, taking a value V_{D+} in the charge phase, a value V_{D-} in the discharge phase, and a value V_{REF} otherwise, the value V_{REF} being a reference value of the input voltage V_{IN} corresponding to a charge balance, that is, to an absence of charge accumulation by the accumulation device 25, the value V_{REF} also being called the pre-charge voltage of the accumulation device 25;
a voltage V_{CAP} applied at the lower terminal of the capacitor 38; a constant voltage source (connected to ground in the example of FIG. 3) or dynamic (FIG. 4)
a threshold voltage V_{TH} of the voltage to current converter 36;
the voltage V_{G}, also called gate voltage V_{G}, applied to the control electrode of the voltage to current converter 36; and the skilled person will observe that the value of this voltage V_{G} depends on the value of the primary memory component 32, such as the value of the resistance R_{SIGMA}, the voltage V_{G} then being variable depending on the value of the resistance R_{SIGMA}, with representation in FIGS. 3 and 4 of both a curve noted V_{G}(Rmin) for a minimum value Rmin of this resistance R_{SIGMA}, and a curve noted V_{G}(Rmax) for a maximum value Rmax of this resistance R_{SIGMA};
the reference potential V_{E} received at the input of the transimpedance amplifier 60, also noted V_{E_CTIA};
the output voltage V_{OUT} at the output of the accumulation device 25; and the skilled person will note that the value of this output voltage V_{OUT} also depends on the value of the primary memory component 32, such as the value of the resistance R_{SIGMA}, the output voltage V_{OUT} then being variable depending on the value of the resistance R_{SIGMA}, with representation in FIGS. 3 and 4 of both a curve noted V_{OUT}(Rmin) for the minimum value Rmin of this resistance R_{SIGMA}, and a curve noted V_{OUT}(Rmax) for the maximum value Rmax of this resistance R_{SIGMA}; and
the ground potential GND of the electrical ground.

The voltages represented in FIGS. 6 and 8 are each from among those defined above.

The electronic circuit 10, according to the invention, forms a transient Gaussian generator with RTN noise and uses the read variability of the primary 32 and the secondary 52 memory components to construct a transient Gaussian generator, such a generator being particularly useful for the hardware implementation of Bayesian neural networks. The properties of each Gaussian distribution are then controlled by a pair of mean and standard deviation values, each being stored in a respective memory component 32, 52, each standard deviation value being stored in a respective primary memory component 32 and each mean value in a respective secondary memory component 52.

For reading these values, the principle is to perform a charge accumulation via the accumulation device 25, the total amount Qₜₒₜ then being the sum of the primary amount Q_{σ} of charges from said primary cell 30 and the secondary amount Q_{μ} of charges from said secondary cell 50, and this total amount Qₜₒₜ being related to the output voltage V_{OUT} at the output of the accumulation device 25 via the following equation:

$${Q}_{t o t} = {Q}_{σ} + {Q}_{μ} = {C}_{CTIA} \cdot ( {V}_{E} - {V}_{O U T} ) \qquad [ 1 ]$$

where Qₜₒₜ represents the total amount,
Q_{σ} represents the primary amount,
Q_{μ} represents the secondary amount,
C_{CTIA} represents the capacity of the feedback capacitor 64 of a respective capacitive transimpedance amplifier of the accumulation device 25,
V_{E} represents the reference potential received at the input of the transimpedance amplifier, this reference potential V_{E} being, for example, equal to the value V_{REF}, that is, to the pre-charge voltage of the accumulation device 25 and
V_{OUT} represents the output voltage of said respective capacitive transimpedance amplifier.

As represented notably in FIG. 1, the primary amount Q_{σ} of charges from said primary cell 30 corresponds to the charge variation resulting on the one hand from a current iσ+ flowing from the respective primary cell 30 to the accumulation device 25 and on the other hand from a current iσ− flowing in the opposite direction from the accumulation device 25 to the respective primary cell 30.

More precisely, the primary amount Q_{σ} satisfies the following equation:

$${Q}_{σ} = {i}_{σ +} \cdot {t}_{1} - {i}_{σ -} \cdot {t}_{2} \qquad [ 2 ]$$

where Q_{σ} represents the primary amount,
iσ+ represents the current flowing from the respective primary cell 30 toward the accumulation device 25 during the charge phase with the first voltage value V_{TOP+} applied to the corresponding source line SLj, for a first duration t₁; and advantageously in the presence of the voltage to current converter 36 amplifying the voltage variations, with the higher value V_{D+} of the additional potential V_{D};
iσ− represents the current flowing in the opposite direction from the accumulation device 25 toward the respective primary cell 30 during the discharge phase with the second voltage value V_{TOP-} applied to said source line SLj, during a second duration t₂; and advantageously in the presence of the voltage to current converter 36 amplifying the voltage variations, with the lower value V_{D-} of the additional potential V_{D}.

The secondary amount Q_{μ} of charges from said secondary cell 50 results from a current iμ flowing from the respective secondary cell 50 toward the accumulation device 25.

More precisely, the secondary amount Q_{μ} satisfies the following equation:

$${Q}_{μ} = {i}_{μ} \cdot {t}_{3} \qquad [ 3 ]$$

where Q_{μ} represents the secondary amount,
iμ represents the current flowing from the respective secondary cell 50 toward the accumulation device 25 during the charge phase, for a third duration t₃, distinct and independent of the first and second durations t₁, t₂.

To avoid a correlation between the mean and standard deviation values, each current iσ on the one hand and iμ on the other hand is sampled independently, but not necessarily sequentially by the accumulation device 25.

For the respective primary cell 30, due to the currents iσ+, iσ− flowing in the opposite direction successively during the charge and discharge phases, the primary amount Q_{σ} presents a distribution the mean value of which is independent of the value of the primary memory component 32, such as the value of the resistance R_{SIGMA}, and the variance results of which from the noise RTN of the primary memory component 32. The primary amount Q_{σ} then satisfies the following equations:

$$E ( {Q}_{σ} ) = constante \sim 0 \qquad [ 4 ]$$

$$V ( {Q}_{σ} ) = F ( {R}_{SIGMA} ) \qquad [ 5 ]$$

where Q_{σ} represents the primary amount,
E represents the expectation
V represents the variance,
F represents a first mathematical function, and
R_{SIGMA} represents the resistance of the primary memory component 32.

For the respective secondary cell 50, the secondary memory component 52 is in the form of any non-volatile memory as long as the ratio between the variance and the mean remains acceptable. A range of acceptable values for this ratio between the variance and the mean is typically predefined, for example, depending on the concerned application, and/or following measurements and/or simulations performed. For example, the range of acceptable values for this ratio between the variance and the mean is [0; 0.1], in other words, a variance at most equal to 10% of the mean.

The secondary amount Q_{μ} then satisfies the following equations:

$$E ( {Q}_{μ} ) = G ( {R}_{M U} ) \qquad [ 6 ]$$

$$V ( {Q}_{μ} ) = constante \sim 0 \qquad [ 7 ]$$

where Q_{μ} represents the secondary amount,
E represents the expectation
V represents the variance,
G represents a second mathematical function, and
R_{MU} represents the resistance of the secondary memory component 52.

In addition, in the presence of the voltage to current converter 36, it allows to amplify the variations of the gate voltage V_{G} between its gate electrode and the primary memory component 32. Advantageously, a strong dependence between the value, such as the resistance R_{SIGMA}, of the primary memory component 32 and the gate voltage V_{G} allows to better measure these fluctuations. Two levers are then possible, a first lever is a process parameter by ensuring that the noise level, such as the noise RTN, is maximal at the highly resistive state, also called HRS (from the English High Resistive State), of the primary memory component 32 and diminishes with the conductance at the low resistive state, also called LRS (from the English Low Resistive State), of said primary memory component 32. A second lever is a design parameter by positioning a cutoff frequency f_{c} of the filter RC, formed by the primary memory component 32 and the capacitor 38, in accordance with a clock frequency f_{clock} of the electronic circuit 10, as will be explained in more detail later with reference to the examples of FIGS. 3 and 4.

According to this addition, the voltage to current converter 36 when it is a MOSFET, advantageously operates in inversion mode, in other words, with its voltage V_{GS} greater than the threshold voltage V_{TH}, to avoid a log-normal distribution. Indeed, when V_{GS} is less than V_{TH}, the MOSFET operates below the threshold and the current is an exponential function of the gate-source voltage V_{GS}. If the voltage V_{GS} follows a normal law as a function of time, the measured current would follow a log-normal law by definition.

The noise RTN changes the value, such as the resistance R_{SIGMA}, of the primary memory component 32 around its nominal values. In the ideal case, illustrated in the upper part of FIG. 6, the voltage values V_{TOP+}, V_{TOP-} are chosen so that in the absence of variation of the resistance R_{SIGMA}, the initial value of the output voltage V_{OUT} is the same as the final value of the output voltage V_{OUT}: the continuous part, or DC, is then removed.

Nevertheless, during the charge or discharge phases, some RTN events may occur, the resistance R_{SIGMA} also being subject to thermal noise.

The accumulated charge Qₜₒₜ being limited by the capacity C_{CTIA} of the feedback capacitor 64 according to the relation Qₜₒₜ=C_{CTIA}·(V_{E}−V_{OUT}) from the previous equation [1], the second type, called resistive, of the primary cell 30, according to the first example without the addition of variable conductance and without the voltage to current converter 36, is interesting if one can control with precision a short pulse of the voltage V_{TOP} applied to the primary memory component 32 via the corresponding source line SLj. Otherwise, the capacity C_{CTIA} will be saturated.

To avoid saturation and still allow RTN events to occur, the resistance value is sampled using short pulses of said voltage V_{TOP} applied to the primary memory component 32, these pulses being repeated and spaced apart by an arbitrary spacing time, as represented in the lower part of FIG. 6. Ideally, the spacing should be higher than the emission and capture times in order to accumulate different values in the charge/discharge phases.

To accumulate more useful data without saturating the capacity C_{CTIA} of the feedback capacitor 64, one solution is to use another architecture, such as, for example, the second type, called resistive, of the primary cell 30, according to the second example with the addition of the variable conductance 42 and with the voltage to current converter 36, visible in FIG. 7. When the voltage to current converter 36 is passing, the primary cell 30 simplifies into a resistive divider between the resistances R_{SIGMA} of the primary memory component 32 and Rref of the variable conductance 42. For a fixed value of the voltage V_{TOP} applied to the primary memory component 32, any variation of the resistance R_{SIGMA} of the primary memory component 32 will then be seen on the gate voltage V_{G} according to the following equation of a transfer function H:

$$H = \frac{{V}_{G} - {V}_{CV}}{{V}_{T O P} - {V}_{CV}} = \frac{R r e f}{R r e f + {R}_{SIGMA}} \qquad [ 8 ]$$

where V_{G} is the gate voltage applied to the control electrode of the voltage to current converter 36,
V_{TOP} is the voltage applied to the primary memory component 32 via the corresponding source line SLj,
V_{CV} is the voltage applied to the second terminal of the variable resistor 44,
Rref is the value of the variable resistor 44, and
R_{SIGMA} is the resistance of the primary memory component 32.

As for the previous example of FIGS. 5 and 6, a pulse strategy is possible to improve the energy consumption of the primary cell 30, such as represented in FIG. 8. The voltage across the voltage to current converter 36, in other words, the potential difference V_{D}−V_{IN}, can be chosen as small as possible to operate in the linear regime of the MOSFET transistor M_{B}.

For the first type, called capacitive, of the primary cell 30, corresponding to the examples of FIGS. 1 to 4, the implementation of the electronic circuit 10 according to the invention comprises an initial pre-charge phase PC at the voltage V_{OFFSET} of the capacitor 38 and the connection node of the primary switch 34 to the capacitor 38, called floating node, this initial pre-charge phase PC preceding a read RD with charge phase of duration t1 and discharge phase of duration t2 in FIGS. 3 and 4.

For the read RD with charge and discharge phases, the transient signal for the voltage V_{TOP} or for the voltage V_{CAP} is, for example, square or triangular in shape, and the voltage V_{G} depends on the value of the primary memory component 32, such as the value of the resistance R_{SIGMA}. The accumulation of the current flowing through the voltage to current converter 36 then results in an increase in charges, in other words, a charge phase, when the potential difference V_{D}−V_{IN} is positive, that is, when the potential difference V_{D}−V_{REF} is positive; and respectively a decrease in charges, in other words, a discharge phase, when the potential difference V_{D}−V_{IN} is negative, that is, when the potential difference V_{D}−V_{REF} is negative. These charge, and respectively discharge, phases are typically iterated several times over several successive cycles.

The skilled person will therefore observe that when the primary memory component 32 is an oxide-based resistive random access memory, or OxRAM, the potential difference V_{TOP}−V_{G} must be less than the threshold voltage of the OxRAM to avoid erasing the OxRAM.

In the example of FIG. 3, the transient signal for the voltage V_{TOP} is square in shape and the signal of the voltage V_{CAP} is continuous, or DC, the voltage V_{G} then being triangular in shape. In this example of FIG. 3, the whole of the primary memory component 32 and the capacitor 38 then forms a low-pass filter playing the role of an integrator, and the transfer function H then satisfies the following equation:

$$H = \frac{{V}_{G} - {V}_{CAP}}{{V}_{T O P} - {V}_{CAP}} = \frac{1}{1 + x} \qquad [ 9 ]$$

where V_{G} is the voltage applied to the control electrode of the voltage to current converter 36,
V_{TOP} is the voltage applied to the primary memory component 32,
with x satisfying the equation:

$$x = \frac{f}{f c} \qquad [ 10 ]$$

where f is a frequency of the circuit,
fc is the cutoff frequency of the filter, and satisfying the following equation:

$${f}_{c} = \frac{1}{2 \cdot π \cdot {R}_{SIGMA} \cdot {C}_{B L}} \qquad [ 11 ]$$

with R_{SIGMA} the resistance of the primary memory component 32, and
C_{BL} the capacity of the capacitor 38, also noted C in FIGS. 3 and 4.

In FIG. 3, the transfer function H is schematically represented for the minimum Rmin and maximum Rmax values of the resistance R_{SIGMA} of the primary memory component 32, with illustration of the respective cutoff frequencies 1/(2πRmin.C) and 1/(2πRmax.C), where C then denotes the capacity of the capacitor 38.

The skilled person will then notice that in this example the clock frequency f_{clock} is advantageously chosen to be greater than or equal to the cutoff frequency f_{c} of the low-pass filter to use the variability resulting from the resistance R_{SIGMA} of the primary memory component 32. It should be noted that if the clock frequency f_{clock} is equal to 1/(2πRmin.C), the variation of the transfer function H is maximal. When the clock frequency f_{clock} is much greater than the cutoff frequency f_{c}, this is in the attenuation zone of the filter and the relationship between the transfer function H and the resistance R_{SIGMA} is no longer measurable.

In the example of FIG. 4, the signal of the voltage V_{TOP} is continuous, or DC, and the transient signal for the voltage V_{CAP} is triangular in shape, the voltage V_{G} then being square in shape. In this example of FIG. 4, the whole of the primary memory component 32 and the capacitor 38 then forms a high-pass filter playing the role of a differentiator, and the transfer function H then satisfies the following equation:

$$H = \frac{{V}_{G} - {V}_{CAP}}{{V}_{TOP} - {V}_{CAP}} = \frac{x}{1 + x} \qquad [ 12 ]$$

where V_{G} is the potential applied to the control electrode of the voltage to current converter 36 also connected to the first terminal of the capacitor 38,
V_{TOP} is the voltage applied to the primary memory component 32,
V_{CAP} is the voltage applied to the second terminal of the capacitor 38
with x satisfying the previous equation [10].

In FIG. 4, the transfer function H is also schematically represented for the minimum Rmin and maximum Rmax values of the resistance R_{SIGMA} of the primary memory component 32, with illustration of the respective cutoff frequencies 1/(2πRmin.C) and 1/(2πRmax.C), where C then denotes the capacity of the capacitor 38.

The skilled person will also notice that in this example the clock frequency f_{clock} is advantageously chosen to be less than or equal to the cutoff frequency f_{c} of the high-pass filter to use the variability resulting from the resistance R_{SIGMA} of the primary memory component 32. It should be noted that the clock frequency f_{clock} is equal to 1/(2πRmax.C), the variation of the transfer function H is maximal. When the clock frequency f_{clock} is much less than the cutoff frequency f_{c}, this is in the attenuation zone of the filter and the relationship between the transfer function H and the resistance R_{SIGMA} is no longer measurable.

In these examples of FIGS. 2 to 4, the primary cascode 26 allows to limit, or even starve, the discharge of the transimpedance amplifier 60, and also to amplify the fluctuations of the drain current I_{D} of the voltage to current converter 36, when it is of MOSFET type, by modulating the efficiency of a transconductance gm/I_{D}.

The skilled person will observe that the curves of FIGS. 3 and 4 correspond to the electronic circuit of FIG. 2, and that those corresponding to the electronic circuit of FIG. 1 are similar except that the voltage V_{CASCODE} is then removed, since the electronic circuit of FIG. 1 does not comprise the primary cascode 26.

For the reading associated with a respective secondary cell 50, in other words, for the accumulation of charges from said secondary cell 50 via the accumulation device 25, typically according to the previous equation [3], it is advantageous to have a low current iμ when the secondary cell 50 is of the first type, notably when the secondary memory component 52 is an oxide-based resistive random access memory, or OxRAM.

This advantageous aspect is, for example, obtained either by having a low value, typically of the order of mV in the state LRS, for the respective voltage V_{TOP} applied to the secondary memory component 52 via the corresponding source line SLk; or by using the selector OxRAM, designed to form/program the series resistance; or even by adding an additional series resistance via the addition of the secondary cascode 28 as in the example of FIG. 9.

Advantageously, the secondary cell 50 is of the second type, the secondary memory component 52 then including a field-effect transistor using a ferroelectric material, the secondary memory component 52 being typically a FeMFET or a FeFET. This presents the advantage of lower sensitivity to noise RTN, compared, for example, to the noise RTN of an OxRAM, and thus limits the risk of biasing the variability observed on the current from the primary cell 30, for which the primary memory component 32 is advantageously sensitive to noise RTN.

Furthermore, as for an oxide-based resistive random access memory, or OxRAM, the capacity of the FeMFET or FeFET is programmable on several levels, which allows to obtain several levels of value for the secondary amount Q_{μ}, and therefore several levels of mean value of the Gaussian distribution.

The skilled person will observe that the primary memory component 32 is also programmable on several levels, notably when the primary memory component 32 is of the type OxRAM, CBRAM, PCM, MRAM, or even FTJ, which also allows to obtain several levels of value for the primary amount Q_{σ}, and therefore several levels of standard deviation value of the Gaussian distribution.

The matrix arrangement of the primary cells 30 and the secondary cells 50 within the electronic circuit 10 according to the invention will now be described with reference to FIGS. 11 to 14.

In the examples of FIGS. 11 to 14, the primary branch(es) 15 are arranged in one or more parallel columns, each primary branch 15 typically including several primary cells 30 connected in parallel, the primary cells 30 then corresponding to different parallel rows. Similarly, the secondary branch(es) 20 are arranged in one or more parallel columns, each secondary branch 20 typically including several secondary cells 50 connected in parallel, the secondary cells 50 then corresponding to different parallel rows.

In the examples of FIGS. 11 to 14, the voltage notations used are those previously described for FIGS. 1 to 10, with the precision that the voltage V_{C_SIGMA} corresponds to the voltage V_{CASCODE} for the sigma branch, in other words, for the primary branch 15; and respectively that the voltage V_{C_MU} corresponds to the voltage V_{CASCODE} for the mu branch, in other words, for the secondary branch 20.

The skilled person will also observe that in these examples of FIGS. 11 to 14, the primary branch(es) 15 are then arranged in parallel with the secondary branch(es) 50, each of these branches 30, 50 corresponding to a respective column of the matrix arrangement.

According to a first arrangement, the electronic circuit 10 comprises N primary branches 15 and N secondary branches 20 arranged in parallel with each other, N being an integer greater than or equal to 2, and the accumulation device 25 includes a single transimpedance amplifier 60 connected to the primary branches 15 and the secondary branches 20, as represented in FIG. 11. In the example of FIG. 11, the primary branches 15 and the secondary branches 20 are arranged alternately, with a secondary branch 20 in parallel and following a primary branch 15, then another primary branch 15 in parallel and following said secondary branch 20, and thus so on. The skilled person will understand, however, that according to this first arrangement, the order in which the primary branches 15 and the secondary branches 20 are arranged in parallel is of no importance and has no influence on the operation of the electronic circuit 10, and in particular on the accumulation of charges via the accumulation device 25.

FIG. 12 represents a more detailed implementation of the parallel arrangement of a respective primary branch 15 and a secondary branch 20, with the first bit lines BL1 and the source lines SL1 associated with the primary branch 15, and the second bit lines BL2 and the source lines SL2 associated with the secondary branch 20, and with then a primary cell 30 followed by a secondary cell 50 for each respective row, each row being connected to a respective word line WLi. The selection of the source lines SLj, SLk, such as the source lines SL1, SL2, and respectively of the word lines WLi, such as the source lines WL1, WL2, is performed by means of respective selectors 70, also called control logic units.

FIG. 13 is similar to FIG. 12 and represents a more detailed implementation of the parallel arrangement of the two primary branches 15, with the first bit lines BL1 and the first source lines SL1 associated with a first primary branch 15, and the second bit lines BL2 and the second source lines SL2 associated with a second primary branch 15, and then with two successive primary cells 30 for each respective row, each row being connected to a respective word line WLi. The selection of the source lines SL1, SL2, and the word lines WL1, WL2 is also performed by means of respective selectors 70.

According to a second arrangement, the electronic circuit 10 comprises N primary branches 15 and N secondary branches 20 arranged in N pairs of primary branches 15 and the secondary branches 20N being an integer greater than or equal to 2, and the accumulation device 25 includes N transimpedance amplifiers 60, each being connected to a respective pair of primary branches 15 and the secondary branches 20, as represented in the upper part of FIG. 14.

This second arrangement presents the advantage of being able to perform charge accumulations in parallel for each pair of primary branches 15 and the secondary branches 20, and therefore to be able to generate in parallel the pairs of standard deviation and mean value of the Gaussian distribution.

According to a third arrangement, the electronic circuit 10 comprises a single primary branch 15 and N secondary branches 20 arranged in parallel, N being an integer greater than or equal to 2, and the accumulation device 25 includes a single transimpedance amplifier 60 connected to the primary branches 15 and the secondary branches 20, as represented in the lower part of FIG. 14.

This third arrangement presents the advantage of being able to generate several distinct Gaussian distributions, with several distinct mean values and a single standard deviation value, while requiring a limited number of electronic components, notably branches 15, 20.

1. An electronic circuit for implementing a Bayesian neural network, comprising:
bit lines;
source lines;
at least one word line;
at least one primary branch, each primary branch including at least one primary cell connected between a respective source line and a bit line, each primary cell including a primary memory component and a primary switch connected in series, the primary switch having a control electrode connected to a respective word line,
at least one secondary branch, each secondary branch including at least one secondary cell connected between a respective source line and a bit line, each secondary cell including a secondary memory component and a secondary switch connected between them,
the source lines and the bit lines associated with each secondary branch being distinct from the source lines and the bit lines associated with each primary branch,
an accumulation device connected to the primary branch(es) and secondary branch(es) and configured to accumulate a total amount of electrical charges from a respective pair of cells, the pair being formed of a respective primary cell and a respective secondary cell, the total amount being the sum of a primary amount of charges from said primary cell and a secondary amount of charges from said secondary cell, the primary amount and the secondary amount being accumulated independently of each other.

2. The electronic circuit according to claim 1, wherein the primary amount is accumulated over two successive phases: a charge phase with a first voltage value applied to the corresponding source line, and a discharge phase with a second voltage value applied to said source line, the second value being distinct from the first value.

3. The electronic circuit according to claim 1, wherein each primary branch further includes a voltage to current converter of the primary cell, the voltage to current converter being connected between an additional potential and the accumulation device, the voltage to current converter having a control electrode connected to the primary cell via the corresponding bit line.

4. The electronic circuit according to claim 3, wherein the primary amount is accumulated over two successive phases: a charge phase with a first voltage value applied to the corresponding source line, and a discharge phase with a second voltage value applied to said source line, the second value being distinct from the first value, and
wherein the additional potential presents a value greater than a reference potential at the input of the accumulation device during the charge phase, and a value less than the reference potential at the input of the accumulation device during the discharge phase.

5. The electronic circuit according to claim 3, wherein each primary branch further includes a variable conductance, connected between a reference potential and the control electrode of the voltage to current converter.

6. The electronic circuit according to claim 3, wherein each primary branch further includes a capacitor having one terminal connected to the control electrode of the voltage to current converter and the other terminal to a reference potential.

7. The electronic circuit according to claim 6, wherein each primary branch includes an auxiliary switch connected between the terminal of the capacitor connected to said control electrode and a pre-charge potential of the capacitor.

8. The electronic circuit according to claim 1, wherein the electronic circuit further includes a cascode, called primary cascode, connected between each primary branch and the accumulation device.

9. The electronic circuit according to claim 1, wherein each primary memory component is a memory sensitive to random telegraph noise.

10. The electronic circuit according to claim 9, wherein each primary memory component is a memory chosen from among the group consisting of: an oxide-based resistive memory; a conductive bridging random access memory; a phase-change memory; a magnetic random access memory; and a ferroelectric stack memory.

11. The electronic circuit according to claim 1, wherein each secondary memory component is a memory chosen from among the group consisting of: an oxide-based resistive memory; a conductive bridging random access memory; a phase-change memory; a magnetic random access memory; and a ferroelectric stack memory.

12. The electronic circuit according to claim 11, wherein the secondary memory component and the secondary switch are connected in series between the respective source line and the bit line, the secondary switch having a control electrode connected to a respective word line.

13. The electronic circuit according to claim 1, wherein each secondary memory component is a component chosen from the group consisting of: a ferroelectric memory field-effect transistor; and a ferroelectric field-effect transistor.

14. The electronic circuit according to claim 13, wherein the secondary memory component is connected between the respective source line and the bit line, and the secondary switch is connected between a word line and a control electrode of the secondary memory component.

15. The electronic circuit according to claim 1, wherein the electronic circuit further includes a cascode, called secondary cascode, connected between each secondary branch and the accumulation device.

16. The electronic circuit according to claim 1, wherein the accumulation device includes at least one transimpedance amplifier.

17. The electronic circuit according to claim 16, wherein the electronic circuit comprises N primary branches and N secondary branches arranged in N pairs of primary and secondary branches, and the accumulation device includes N transimpedance amplifiers, each being connected to a respective pair of primary and secondary branches, N being an integer greater than or equal to 2.
